(19) United States
(12) Patent Application Publication
(10) Pub. No.: US 2003/0188660 A1
(43) Pub. Date: Oct. 9, 2003

(54) Secure scanning mail verifier

(75) Inventors: Thomas J. Foth, Trumbull, CT (US); Kenneth G. Miller, Bethel, CT (US); Jennifer A. Hinsman, Brewster, NY (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/313,405

(22) Filed: Dec. 6, 2002

Related U.S. Application Data
(60) Provisional application No. 60/371,195, filed on Apr. 9, 2002.

(51) Int. Cl. B41L 47/00

(52) U.S. Cl. 101/484

(57) ABSTRACT

A method for capturing mail piece attributes as well as the number of mail pieces contained in the mailing. This is done by securely capturing an image of the mail piece and its thickness. These mail piece attributes can be used to verify barcode quality, readability, and correctness; presort discounts; address correctness; mail piece size; weight based upon mail piece thickness, indicia attributes, etc. Optionally, light reflectivity sensors can verify the glossiness and contrast of the mail pieces. Images and thickness of mail pieces can be sampled and verified against USPS mailing standards and USPS required documentation.

This Application claims the benefit of the filing date of U.S. Provisional Application No. 60/371,195 filed Apr. 9, 2002, which is owned by the assignee of the present Application.

### FIELD OF INVENTION

This invention relates to mailing systems and methods and, more particularly, to systems and methods of verifying mail.

### BACKGROUND OF THE INVENTION

For a long time, the United States Postal Service (USPS) has afforded discounts to its customers if they do some of the work that the USPS would need to perform to prepare the mail for delivery. Since these discounts are based on the performance of the specific work tasks that go beyond the creation and addressing of the mail piece, the USPS must verify that the work was done so that the USPS provides discounts only to those mailers who performed work that is expected to be beneficial to the USPS.

One of the disadvantages of the prior art is that it cost the USPS a great deal of time and money to verify that the mail was properly prepared, i.e., sorted by zip code, properly marked with a postnet bar code, of a uniform size and weight, etc., and the correct postage paid. Another disadvantage of the prior art is that postal verification increased the time for delivering the mail.

### SUMMARY OF THE INVENTION

This invention overcomes the disadvantages of the prior art by reducing the cost of the USPS to verify mail and increase the speed of the process for inducting mail into the postal system. The foregoing automates the process of inspecting and verifying mail as the mail is produced.

The method and system of this invention inspects mail as it is being produced and later verifies the mail, automating a process currently being done by postal workers. This automated process reduces the postal verification costs currently incurred by the USPS. By making mail verification part of the mail production process, the cost of verification is decreased.

The apparatus of this invention is a secure mailing classification and mail face imaging device. It captures mail piece attributes and the number of mail pieces contained in the mailing by securely capturing an image of the mail piece and its thickness. These mail piece attributes can be used to verify barcode quality, readability, and correctness; presort discounts; address correctness; mail piece size; weight based upon mail piece thickness, indicia attributes, etc. Optionally, light reflectivity sensors can verify the glossiness and contrast of the mail pieces. Images and thickness of mail pieces can be sampled and verified against USPS mailing standards and USPS required documentation by mailer side secure software, a third party or the USPS. Mailing documentation preferably would be a Mail.dat format.

Additional advantages of the invention are that it virtually eliminates the need to perform postal verification. A cursory check is all that is required. For instance, an image of the face of the mail piece can be used as a proof of mailing; and, to identify the mailer, data from the mail pieces can be used to create mailing documentation, i.e., a manifest, significantly reducing the cost of inline verification, and enabling the mailer to verify some mail piece attributes in real time while offloading the verification of other mail attributes to when the mail job is completed. This can include verifying these mail attributes when the mail is being transported to the USPS. Thus, the USPS has the ability to see every mail piece in a mailing; twenty-four hours a day, seven days a week, without human intervention. Hence, the invention is less complicated to implement than present systems. This invention requires only minor modifications to mail production machinery; can work in a number of mail creation scenarios (e.g., inserters, sorters, address printers, and meters); and can collect information used to facilitate payments of postage to the USPS.

A further advantage is that the image of the mail piece and the thickness of the mail piece may be used to calculate the weight of the mail piece and, hence, the correct postage.

### BRIEF DESCRIPTION OF THE DRAWINGS

FIG. 1 is a side view of a mail piece being transported;

FIG. 2 is a top view of a mail piece being transported;

FIG. 3 is a block diagram of the components that are used to obtain data capture and verification of the information on the face of mail piece 11;

FIG. 4 is a flow chart of the operation of CPU 25;

FIG. 5 is a flow chart of the verification of mail pieces that may be performed by CPU 25 or by remote verification device 30;

FIG. 6 is a flow chart showing block 250 of FIG. 5 in greater detail;

FIG. 7 is a flow chart showing block 265 of FIG. 6 in greater detail;

FIG. 8 is a flow chart showing block 275 of FIG. 5 in greater detail;

FIG. 9 is a flow chart verifying a mail run against mailing documentation; and

FIG. 10 is a flow chart verifying a mail piece to a mail piece manifest.

### DETAILED DESCRIPTION OF THE DRAWINGS

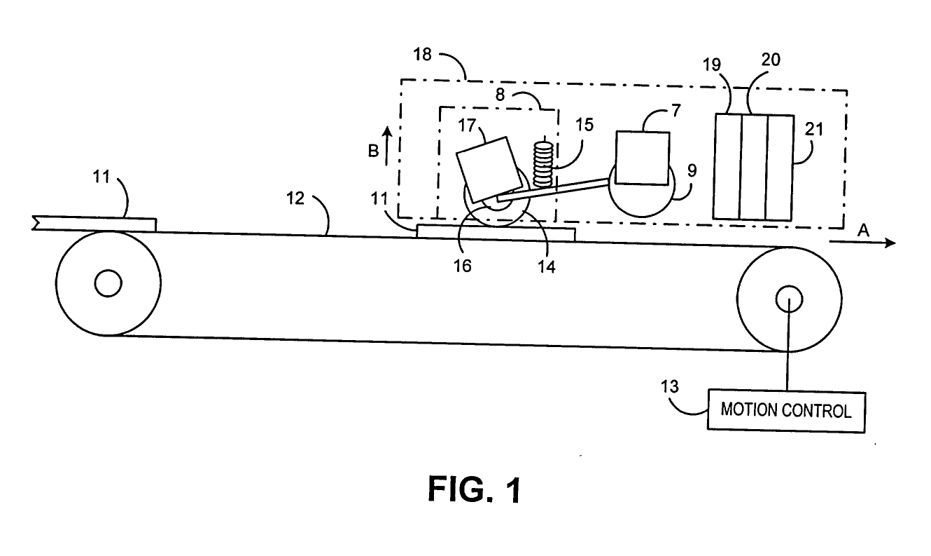

Referring now to the drawings in detail and, more particularly, to FIG. 1, the reference character 11 represents a mail piece in the form of an envelope or flat. Mail piece 11 is transported face side up in direction A by belt 12 and motion control device 13. Belt 12 and motion control device 13 are contained in mail inserting equipment like the series 12 inserters manufactured by Pitney Bowes Inc. of One Elmcroft Road Stamford, Conn. Motion control device 13 controls the starting and stopping of belt 12 and regulates the speed of belt 12. Mail piece 11 passes under data capture device 18. Data capture device 18 includes optical encoder 7, belt spring detector 8, gray coded wheel 9, idler wheel 14, spring 15, gray coded wheel 16, reflectometer 19, illuminator 20 and charged coupled array 21. Idler wheel 14, spring 15, gray coded wheel 16 and optical encoder 17 comprise belt speed detector 8. Detector 8 may be the model AWC58 Bit Parallel Shaft Encoder manufactured by Fraba Systems GmbH of Schanzenstrasse 35, D-51063 Koeln Germany.

Spring 15 is used to place idler wheel 14 against mail piece 11 so that mail piece 11 will be pushed against belt 12 causing mail piece 11 to have its minimum thickness. As mail piece 11 is transported in direction A by belt 12, mail piece 11 causes idler wheel 14 to move in direction B. The deflection of idler wheel 14 causes an angular change in gray coded wheel 9. A series of light emitting diodes and photo detectors (not shown) in optical encoder 7 senses the movement of wheel 9, determining the current position of wheel 9, i.e., the amount of rotation and directional rotation of wheel 14. By knowing the deflection of wheel 14, one may determine the thickness of mail piece 11 since the type and size of the envelope being used for mail piece 11 is known. From the thickness of mail piece 11, one may determine the weight of mail piece 11.

Belt 12 transports mail piece 11 under reflectometer 19, illuminator 20 and charged coupled array 21. Reflectometer 19 may be the model IS485 pairs of red and green filters manufactured by the Sales & Marketing Group—Electronic Components & Devices of The Sharp Corporation of 22-22, Nagaike-cho, Abeno-ku, Osaka 545, Japan. Array 21 may be the model ILX554B black and white array manufactured by Sony Corporation of 7-35 Kitashinagawa 6—chome, Shinagawa-ku, Tokyo 141-0001, Japan. If the Sony model ILX555K color array is used instead of the Sony ILX554B black and white array, there will be no need for reflectometer 19 since the model ILX554B performs the function of reflectometer 19 and array 21. Illuminator 20 comprises a string of light emitting diodes (not shown) to supply light for reflectometer 19 and array 21. The reflectivity of mail piece 11 is measured by array 21 or reflectometer 19 before array 21 detects the edge of mail piece 11 and determines the size of mail piece 11 and reads the information on the face of mail piece 11. The face of mail piece 11 is read to determine whether or not the planet and postnet bar codes and postal indicia on the face of mail piece 11 are readable and to check other information on the face of mail piece 11, i.e., senders address, recipient's address, etc.

Thus, the above may be used to verify bulk mail that is produced by an inserter, sorter, mailing machine system such as a Pitney Bowes Galaxy®), periodical binder, etc. Eliminating the need for verification of bulk mail by the USPS, a cursory check is all that would be required. As mail pieces are transported past the abovementioned components in the mail finishing process, data collection device 18 detects the edge of mail piece 11 and determines its thickness.

Using the deflection of wheel 14 as measured by wheel 9 with the mail piece 11 length and width obtained through the image obtained by array 21, and a predetermined paper density, an approximate mail piece weight can be obtained by utilizing the following chart and equation.

| Bond Paper | Oz/inch² | One Sheet Thickness |
|---|---|---|
| 20 | 0.001562079 | 0.0035 |
| 24 | 0.00187325 | 0.004 |
| 28 | 0.002186495 | 0.005 |
| 60 | 0.004684161 | 0.003 |
| 67 | 0.005229748 | 0.008 |
| 80 | 0.006244166 | 0.004 |
| 110 | 0.008586246 | 0.0085 |

Thickness/one sheet thickness × height × width × (oz/inch² from chart) = weight

Mail piece attributes obtained from the above process include: barcode quality; barcode readability; barcode correctness; presort discounts; address correctness; mail piece size; weight estimation; bar code placement, correct postage, indicia correctness; number of mail pieces in mailing; identification of mailer (secure mail); proof of mailing; and mail piece reflectance. These mail piece attributes may be used to create a manifest of the mailing.

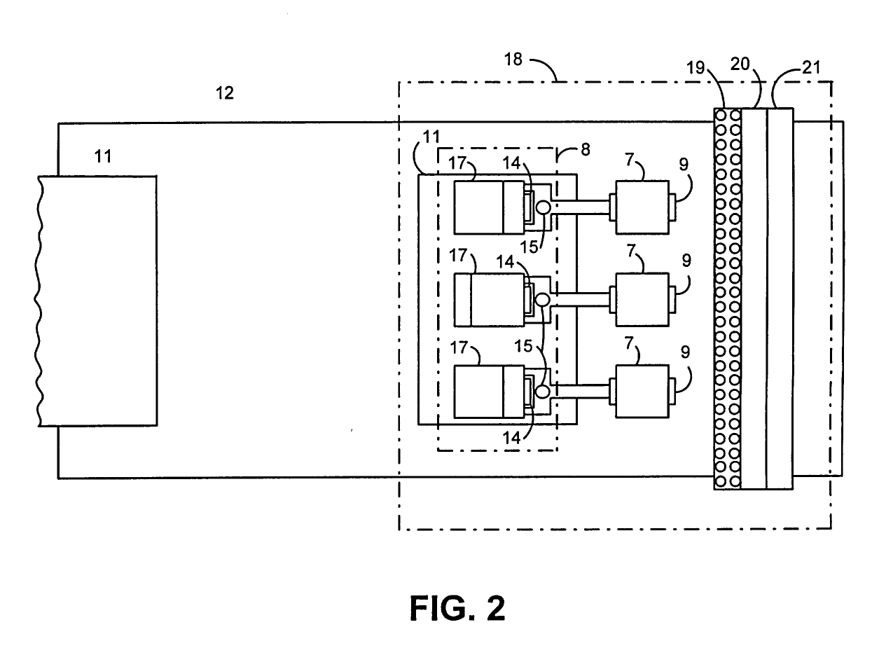

FIG. 2 is a top view of mail piece 11 being transported, where a plurality of encoders 7 contained in data collection device 18 are used to determine an average thickness of mail piece 11. An average thickness of mail piece 11 will give a more accurate weight determination for mail piece 11 since mail piece 11 may contain an insert that is not the same size as other material contained within mail piece 11.

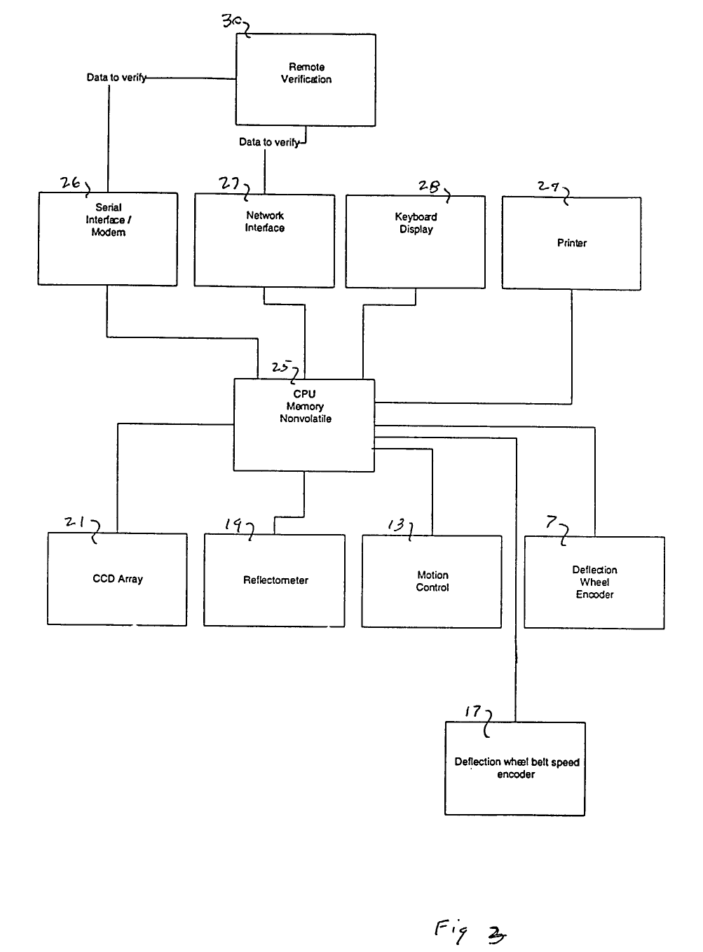

FIG. 3 is a block diagram of the components that are used to obtain data capture and verification of the information on the face of mail piece 11. Information from motion control 13, deflection wheel encoders 7 and 17, reflectometer 19 and array 21 are inputted to central processing unit (CPU) 25. CPU 25 contains permanent memory as well as nonvolatile storage memory as found in a conventional personal computer platform.

Serial interface/modem 26 is coupled to CPU 25 and to remote verification device 30, and network interface 27 is coupled to CPU 25 and to remote verification device 30. Keyboard and display 28 is coupled to CPU 25 and printer 29 is coupled to CPU 25. Serial interface/modem 26 may be the model 005687-03 manufactured by US Robotics, of 935 National Parkway, Shaumburg, Ill. 60173. Network interface 27 may be the model LNE100TX manufactured by Linksys of 17401 Armstrong Ave. Irvine, Calif. 92614. Remote verification device 30 is a personal computer or server.

Serial interface/modem 26 allows CPU 25 to communicate with remote verification device 30 so that the USPS and/or a representative of the USPS can inspect all of the data collected about mail piece 11 by data collection device 18, including the images appearing on the faces of mail piece 11, and download the images and data captured by data collection device 18. The foregoing may inform the USPS in real time, or any convenient time, of the mail pieces that are going to enter the mail stream. The USPS may use the foregoing to ask the mailer for certain desired information.

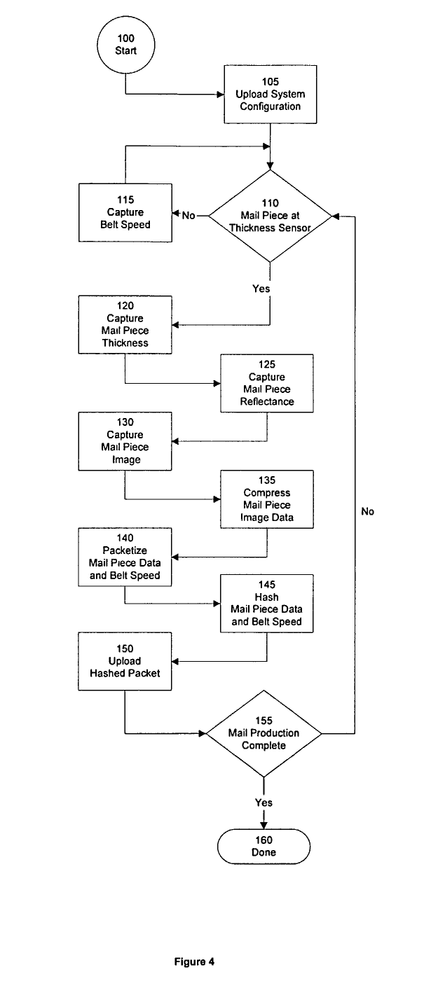

FIG. 4 is a flow chart of the operation of CPU 25. The program starts in block 100. Then the program goes to block 105 to upload the system configuration. Now the program goes to decision block 110. Decision block 110 determines whether or not mail piece 11 (FIG. 1) is at idler wheel 14. If block 110 determines that mail piece 11 is not at idler wheel 14, then the program goes to block 115 to capture the speed of belt 12 using idler wheel 14. If block 110 determines that mail piece 11 is at idler wheel 14, then the program goes to block 120 to capture the thickness of mail piece 11 by utilizing idler wheel 14 and gray coded wheel 9. Now the program goes to block 125 to capture the reflectance of the face of mail piece 11 using reflectometer 19. Then the program goes to block 130 to capture the image appearing on the face of mail piece 11 using CCD array 21. Then the program goes to block 135 to compress the image data appearing on the face of mail piece 11. At this point, the program goes to block 140 to packetize, i.e., place in a data frame the data appearing on the face of mail piece 11, the speed of belt 12, and the thickness of mail piece 11. Now the program goes to block 145 to compute a hash of the data appearing on the face of mail piece 11 and the speed of belt 12 to obtain a digital signature. Then the program goes to block 150 to upload the hashed packet to remote verification device 30 (FIG. 3) via serial interface 26 or network interface 27. Now the program goes to decision block 155. Decision block 155 determines whether or not the mail production is complete by noting the user entry in keyboard display 28. If block 155 determines that the mail production is not complete, the program goes back to the input of block 110. If block 155 determines that the mail production is complete the program goes to block 160 and is done.

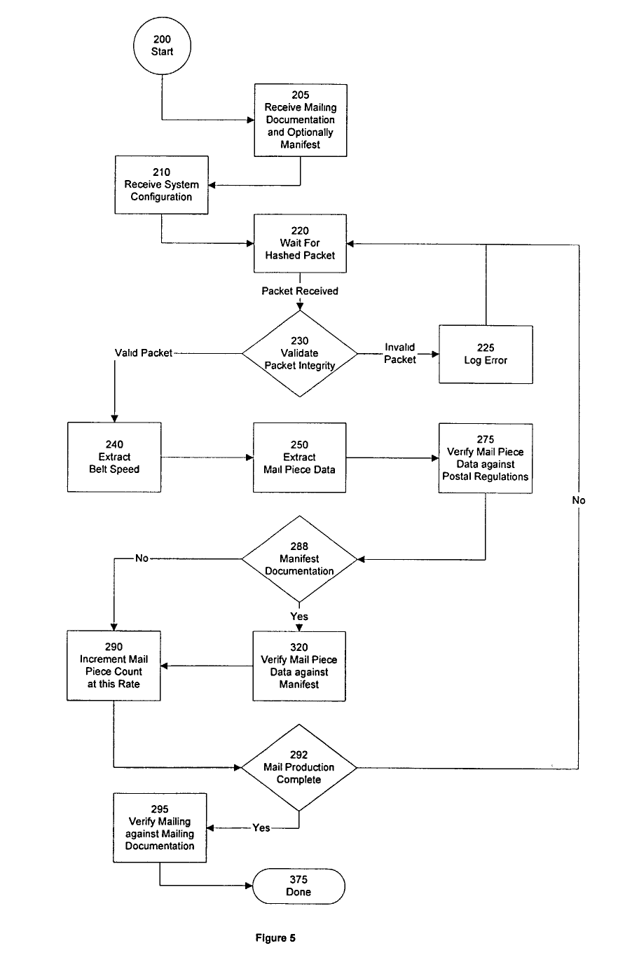

FIG. 5 is a flow chart of the verification of mail pieces that may be performed by CPU 25 or by remote verification device 30. Verification of the mail piece attributes may be done at the end of the mail production run or in real time during the mailing production run while important mail piece quality attributes may be verified and with a complete verification done at the end of the mail production. The last approach would allow a mailer to fix problems during the mail production run, i.e., correct poor printing quality on the face of mail piece 11.

After the mail production run is completed, a complete verification may occur. At this point, specific mail piece attributes or all mail piece attributes may be verified at the mailer's site with secure software; the USPS; or a third party (e.g., verification service).

If the mail pieces have a machine-readable code on them, such as Planet codes with Postnet barcodes, or if the machine securely applies the Planet codes (and a Postnet barcode if not already applied), the USPS can later use the combination of Planet codes and Postnet barcode to index into a table that would allow the USPS to pull up an image of a mail piece as it is passing through the USPS' sorting machines. Indexing of the images with the Planet codes-Postnet barcode combination may occur in realtime or in a post-processing step. If these images do not match, then fraud is detected.

Verification starts in block 200. Then the program goes to block 205 to download mailing documentation and optionally the manifest documentation. Now the program goes to block 210 to receive the system configuration. Then the program goes to block 220 to wait for the hashed packet. At this point, the program goes to decision block 230. Decision block 230 validates the packet integrity by determining whether or not the hash is correct. If block 230 determines that the hash is incorrect, i.e., the hash is invalid, the program goes to block 225 to log the error. Then the program goes back to the input of block 220.

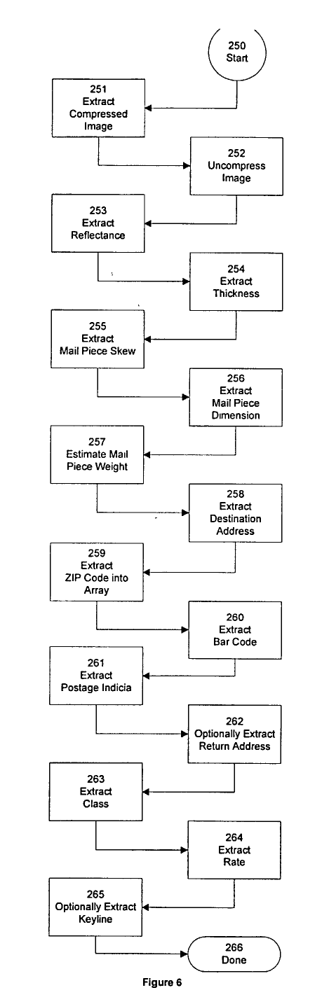

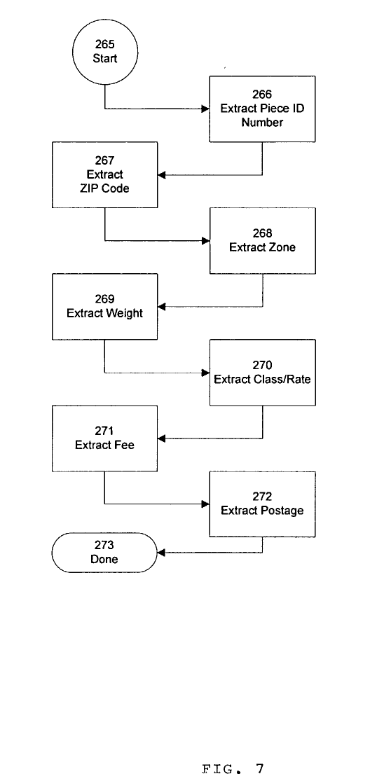

If block 230 determines that the hash is correct, i.e., the hash is valid, the program goes to block 240 to extract the speed of belt 12 (FIG. 1). Now the program goes to block 250 to extract mail piece data. Block 250 will be more fully described in the description of FIG. 6. Then, the program goes to block 275 to verify mail piece data against postal regulations. Block 275 will be more fully described in the description of FIG. 7. Now the program goes to decision block 288 to determine whether or not there is manifest documentation. If block 288 determines that there is manifest documentation, the program goes to block 320 to verify the mail piece against the manifest. Then the program goes to block 290 to increment the mail piece count at this rate. If block 288 determines that there is no manifest, the program goes to block 290 to increment the mail piece count at this rate. Then the program goes to block 292 to determine whether or not the mail run is complete. If block 292 determines that the mail run is not complete, the program goes to the input of block 220. If block 292 determines that the mail production run is complete, the program goes to block 295 to verify the mailing against mailing documentation. Then the program goes to block 375 and is done.

FIG. 6 is a flow chart showing block 250 of FIG. 5 in greater detail. The program starts in block 250 and then goes to block 251 to extract the compressed mail piece image data from block 135 (FIG. 4). Now the program goes to block 252 to uncompress the image. Then the program goes to block 253 to extract the reflectance of mail piece 11. Now the program goes to block 254 to extract the thickness of mail piece 11. At this point, the program goes to block 255 to extract the skew of mail piece 11 on belt 12 (FIG. 1). Then the program goes to block 256 to extract the dimensions of mail piece 11 from the compressed image. Now the program goes to block 257 to estimate the weight of mail piece 11 based upon the deflection of idler wheel 14, the dimensions obtained from block 256 and the following equation:

Thickness/one sheet thickness×height×width×(oz/inch² from chart)=weight.

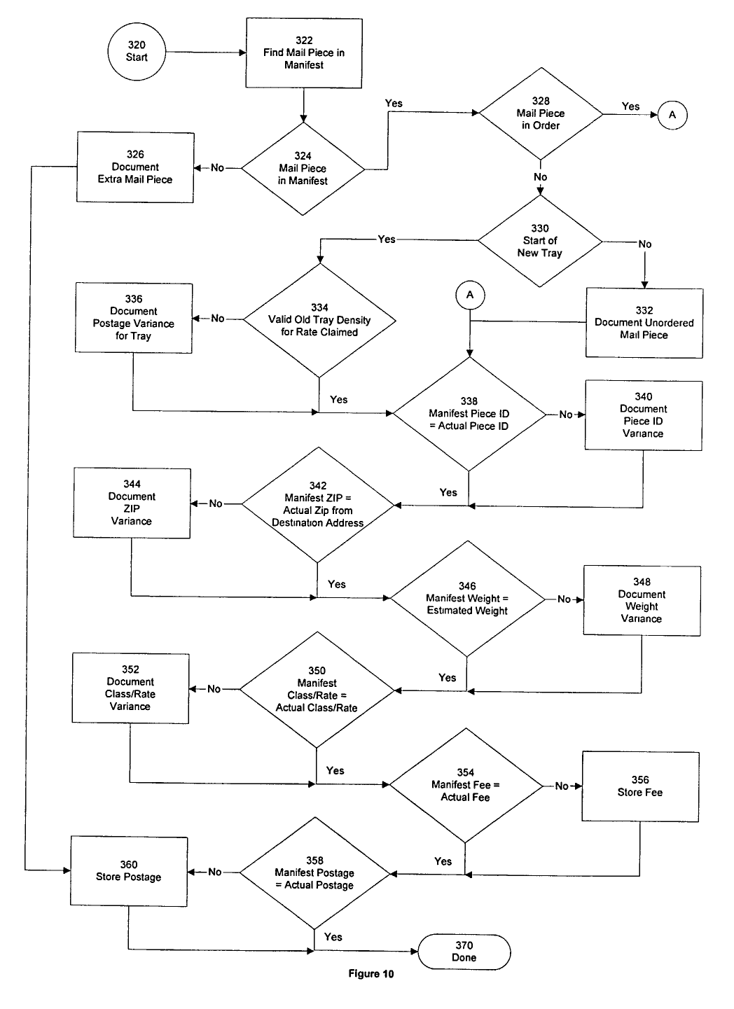

Then the program goes to block 258 to extract the destination address of mail piece 11. Now the program goes to block 259 to extract the destination address zip code from mail piece 11. Then the program goes to block 260 to extract the planet bar code if present from mail piece 11. Then the program goes to block 261 to extract the postage indicia from mail piece 11. Now the program goes to block 262 to optionally extract the return address appearing on mail piece 11. Then the program goes to block 263 to extract the postal class appearing on mail piece 11. Now the program goes to block 264 to extract the postal rate appearing on mail piece 11. Now the program goes to block 265 to optionally extract the keyline appearing on mail piece 11. Block 265 will be more fully described in the description of FIG. 10. USPS requires that a keyline be printed on mail pieces that are processed with a manifest. The key line contains: a consecutive identification number for all mail pieces in the batch, the mail piece weight in ounces, the rate category, and the postage paid. Now the program goes to block 266 and is done.

FIG. 7 is a flow chart showing block 265 of FIG. 6 in greater detail. The program begins in block 265. Then the program goes to block 266 to extract the mail pieces identification number. Now the program goes to block 267 to extract the zip code. Then the program goes to block 268 to extract the zone from the keyline. Now the program goes to block 269 to extract the weight from the keyline. Now the program goes to block 270 to extract the class rate from the keyline. Then the program goes to block 271 to extract any additional postal fees, i.e., insurance from the keyline. Now the program goes to block 272 to extract the postage from the keyline. Then the program goes to block 273 and is done.

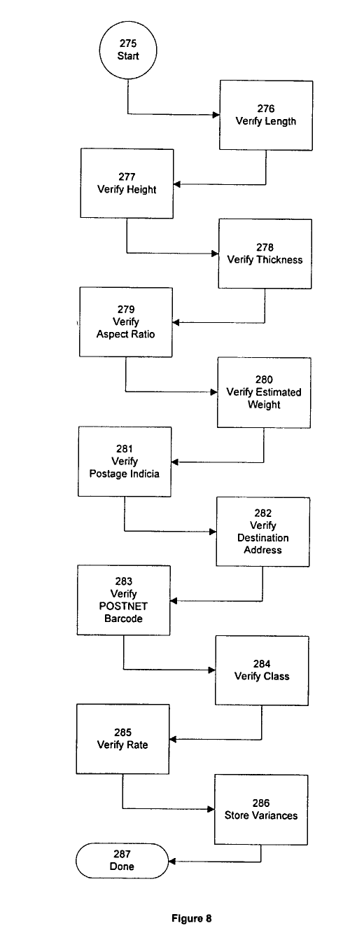

FIG. 8 is a flow chart showing block 275 in greater detail. The program starts in block 275. Then the program goes to block 276 to verify the length of mail piece 11. Now the program goes to block 277 to verify the height of mail piece 11. Now the program goes to block 278 to verify the thickness of mail piece 11. Then the program goes to block 279 to verify the aspect ratio of mail piece 11. Then the program goes to block 280 to verify the estimated weight of mail piece 11. Now the program goes to block 281 to verify the postage indicia appearing on mail piece 11. Then the program goes to block 282 to verify the destination address appearing on mail piece 11. Now the program goes to block 283 to verify the postnet bar code. Then the program goes to block 284 to verify the class. Then the program goes to block 285 to verify the mail piece rate. Now the program goes to block 286 to store any variances in the verification. Then the program goes to block 287 and is done.

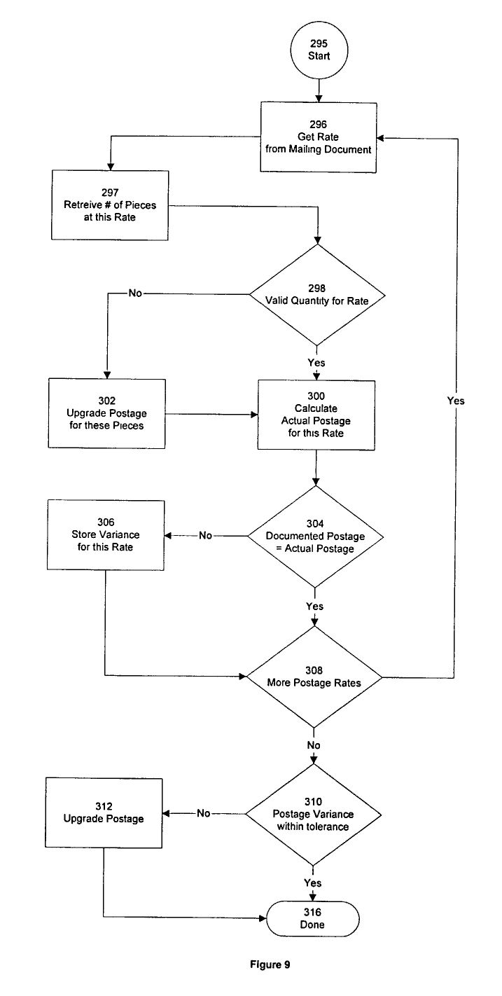

FIG. 9 is a flow chart verifying a mail run against mailing documentation. The program begins in block 295. Then the program goes to block 296 to get the rate from the mailing document. Then the program goes to block 297 to retrieve the number of pieces at this rate. Now the program goes to decision block 298. Block 298 determines whether or not there is a valid quantity of mail pieces for this rate. If block 298 determines that there is not a valid quantity of mail pieces the program goes to block 302 to upgrade the postage for these additional mail pieces. Then the program goes to block 300. If block 298 determines that there is a valid quantity of mail pieces, the program goes to block 300 to calculate the actual postage for this rate.

Now the program goes to decision block 304. Block 304 determines whether or not the documented postage equals the actual postage. If block 304 determines that the documented postage does not equal the actual postage, the program goes to block 306 to store the variance for this rate. Then the program goes to decision block 308. If block 304 determines that the documented postage equals the actual postage, the program goes to decision block 308. Block 308 determines whether or not there are any more postage rates. If block 308 determines that there are more postage rates the program goes to block 296. If block 308 determines that there are no more postage rates, the program goes to decision block 310. Block 310 determines whether or not the postage variance is within tolerance. If block 310 determines that the postage variance is not within tolerance, then the program goes to block 312 to upgrade the postage. If block 310 determines that the postage variance is within tolerance or block 312 has upgraded the postage, the program goes to block 316 and is done.

FIG. 10 is a flow chart verifying a mail piece to a mailing manifest. The program begins in block 320. Then the program goes to block 322 to find the mail piece in the manifest. Then the program goes to decision block 324. Decision block 324 determines whether or not the mail piece is in the manifest. If block 324 determines that the mail piece is not in the manifest, the program goes to block 326 to document the extra mail piece. Then the program goes to block 360 to store the postage. If block 324 determines that the mail piece is in the manifest, the program goes to decision block 328. Block 328 determines whether or not the mail piece is in the correct order. If block 328 determines that the mail piece is in the correct order, the program goes to decision block 334. If block 328 determines that the mail piece is not in the correct order, the program goes to decision block 330. Block 330 determines whether or not a new mail tray should be started. If block 330 determines that a new mail tray should not be started, the program goes to block 332 to document the unordered mail piece. Then the program goes to decision block 338. If block 330 determines that a new mail tray should be started, the program goes to decision block 334. Decision block 334 determines whether or not there is a valid old mail tray density for the rate claimed. If block 334 determines that there is not a valid old mail tray density for the rate claimed, the program goes to block 336 to document the postage variance for the old tray. Then the program goes to decision block 338. If block 334 determines that there is a valid old mail tray density for the rate claimed, the program goes to decision block 338.

Block 338 determines whether or not the manifest piece identification equals the actual piece identification. If block 338 determines that the manifest piece identification does not equal the actual piece identification, the program goes to block 340 to document the piece identification variance. Then the program goes to decision block 342. If block 338 determines that the manifest piece identification equals the actual piece identification, the program goes to decision block 342. Decision block 342 determines whether or not the manifest zip code equals the actual zip code obtained from the destination address. If block 342 determines that the manifest zip code does not equal the actual zip code obtained from the destination address, the program goes to block 344 to document the zip code variance. Then the program goes to decision block 346. If block 342 determines that the manifest zip code equals the actual zip code obtained from the destination address, the program goes to decision block 346.

Decision block 346 determines whether or not the manifest weight equals the estimated weight. If block 346 determines that the manifest weight does not equal the estimated weight, the program goes to block 348 to document the weight variance. Then the program goes to decision block 350. If block 346 determines that the manifest weight equals the estimated weight, the program goes to decision block 350. Decision block 350 determines whether or not the manifest class/rate equals the actual class/rate. If block 350 determines that the manifest class/rate does not equal the actual class/rate, the program goes to block 352 to document the class/rate variance. Then the program goes to decision block 354. If block 350 determines that the manifest class/rate equals the actual class/rate, the program goes to decision block 354. Block 354 determines whether or not the manifest fee equals the actual fee. If block 354 determines that the manifest fee does not equal the actual fee, the program goes to block 356 to store the fee. If block 354 determines that the manifest fee equals the actual fee, the program goes to decision block 358. Block 358 determines whether or not the manifest postage equals the actual postage. If block 358 determines that the manifest postage does not equal the actual postage, the program goes to block 360 to store the postage. If block 358 determines that the manifest postage equals the actual postage or block 360 has stored the postage, the program goes to block 370 and is done.

The above specification describes a new and improved method for performing secure, in-line verification of mail. It is realized that the above description may indicate to those skilled in the art additional ways in which the principles of this invention may be used without departing from the spirit. Therefore, it is intended that this invention be limited only by the scope of the appended claims.

What is claimed:

1. A method for performing secure, in-line verification of mail, said method comprises the steps of:
a. imaging the face of a mail piece;
b. determining the thickness of the mail piece;
c. using the information in steps a. and b. to obtain attributes of the mail piece.

2. The method claimed in claim 1, wherein the face of the mail piece contains recipient's and sender's name and address and the evidencing of postage.

3. The method claimed in claim 1, further including the step of:
analyzing the image to determine various attributes.

4. The method claimed in claim 3 wherein the attributes are: barcode quality; barcode readability; barcode correctness; address correctness; mail piece size; weight estimation; indicia correctness; identification of mailer (secure mail); proof of mailing; and mail piece reflectance.

5. The method claimed in claim 1, wherein the in-line verification is performed in real time.

6. The method claimed in claim 1, wherein the in-line verification is performed after a mail run.

7. The method claimed in claim 1, wherein step b. further includes the steps of:
placing the mail piece under an idler wheel;
measuring the deflection of the idler wheel; and
using the deflection of the idler wheel to determine the thickness of the mail piece.

8. The method claimed in claim 1, further including the steps of:
repeating steps a., b., and c. for many mail pieces.

9. The method claimed in claim 8, wherein the face of the mail pieces contains recipient's and sender's name and address and the evidencing of postage.

10. The method claimed in claim 9, further including the step of:
analyzing the images to determine various attributes.

11. The method claimed in claim 10 wherein the attributes are: barcode quality; barcode readability; barcode correctness; presort discounts; address correctness; mail piece size; weight estimation; indicia correctness; number of mail pieces in mailing; identification of mailer (secure mail); proof of mailing; and mail piece reflectance.

12. The method claimed in claim 10, wherein the in-line verification is performed in real time.

13. The method claimed in claim 10, wherein the in-line verification is performed after a mail run.

14. The method claimed in claim 10, wherein step b. further includes the steps of:
placing the mail piece under an idler wheel;
measuring the deflection of the idler wheel; and
using the deflection of the idler wheel to determine the thickness of the mail piece.

15. The method claimed in claim 1, further including the steps of:
repeating steps a., b., and c. for a predetermined number of mail pieces.

16. The method claimed in claim 15, wherein the face of the mail pieces contains recipient's and sender's name and address and the evidencing of postage.

17. The method claimed in claim 15, further including the step of:
analyzing the images to determine various attributes.

18. The method claimed in claim 17 wherein the attributes are: barcode quality; barcode readability; barcode correctness; presort discounts; address correctness; mail piece size; weight estimation; indicia correctness; number of mail pieces in mailing; identification of mailer (secure mail); proof of mailing; and mail piece reflectance.

19. The method claimed in claim 15, wherein the in-line verification is performed in real time.

20. The method claimed in claim 15, wherein the in-line verification is performed after a mail run.

21. The method claimed in claim 15, wherein step b. further includes the steps of:
placing the mail piece under an idler wheel;
measuring the deflection of the idler wheel; and
using the deflection of the idler wheel to determine the thickness of the mail piece.
